(19) United States
(12) Patent Application Publication
(10) Pub. No.: US 2018/0310696 A1
(43) Pub. Date: Nov. 1, 2018

(54) Lanyard Assembly

(71) Applicant: Getter Right LLC, Big Bend, WI (US)

(72) Inventor: Christopher A. Getter, Big Bend, WI (US)

(21) Appl. No.: 15/498,699

(22) Filed: Apr. 27, 2017

(51) Int. Cl. A45F 3/14; A45F 5/00; A44B 11/06

(52) U.S. Cl. CPC A45F 3/14; G09F 21/02; A44B 11/06; A45F 5/00

(57) ABSTRACT

A multi-use lanyard assembly that includes an elongate flexible body, a pair of clamps that engage the elongate flexible body, and a pair of clasps that are secured to the opposite distal ends of the elongate flexible body. The elongate flexible body is preferably provided as a cord or a strap that is folded over upon itself to define respective first and second portions of the elongate flexible body. Each of the clamps is oriented to be moveable along and engage both of the first and second portions of the elongate flexible body. Each of the first and second clamp portions is securable relative to the first and second portions of the elongate flexible body at various discrete positions such that the lanyard assembly can achieve various configurations associated with securing the lanyard assembly and associated accessories relative to a user.

### FIELD OF THE INVENTION

The present invention relates to a securing device wearable by a user, and more specifically, to a lanyard assembly that can be oriented in multiple configurations to support items commonly hand carried by a wearer such that the hands of the wearer are free for other purposes.

### BACKGROUND OF THE INVENTION

Vacationers, convention attendees, and/or people who are just generally active commonly leave personal quarters for extended periods of time and must transport the things they anticipate needing for a giving duration or activity upon their body. Although a personal pack type container, such as a backpack, waist pack, or other more generally closable containers, may be desirable for some activities or durations, more minimalist persons tend to prefer not to transport and keep track of such containers during their time away from their respective personal quarters.

As a more minimalist approach to transporting items, some users employ use of section of rope or strap in their activities. A common configuration of such a carrying device is as a lanyard or an elongate flexible cord or ribbon that can be passed around the neck, shoulder, or wrist for holding objects. A very common use of such lanyards is as a name tag or badge holder during conventions or the like. Although such lanyard assemblies can be used to tie objects together or to other structures, unfortunately, such lanyard assemblies are commonly provided in fixed or non-adjustable configuration which limits their use aside from supporting objects around the neck or wrist of the wearer.

Additionally, if used to secure larger or heavier objects, such fixed shape lanyard assemblies leave the objects only loosely restrained such that the objects and lanyard assembly are generally freely translatable relative to the wearer. For instance, when bending over, objects hung from the lanyard assembly may strike surfaces or children near the wearer. Additionally, when turning, any objects supported by the lanyard assembly may swing to other locations relative to the wearer or impede motion of the arms of the wearer. Recognizing such short comings, others provide various multiple configuration lanyard or strap assemblies. Unfortunately, such approaches are not without their respective drawbacks. Some such configurations include adjustable but separable strap portions. Although such approaches can accommodate various configurations of the lanyard assembly, the ability of the lanyard or strap assembly to separate from one another can result in unexpected separation between the respective portions of the assembly during use. Still further, such approaches can result in loss or misplacement of discrete portions of the lanyard assembly.

Still others provide multiple configuration lanyard assemblies that include one or more robust closure mechanisms, such as clasps, latches, or buckles that selectively cooperate with one another to define a desired configuration of the lanyard assembly during use. Such approaches detract from the compact nature of the lanyard assembly both when in use and when stored or not in use. Further still, structural failure of any portion of the selectively operable closure mechanisms limits the ability of the lanyard assembly to achieve one or more of the available configurations due to failure of a single component of the assembly.

Still further, many of the lanyard assemblies that are capable of achieving multiple configurations secure discrete portions of the discrete closure mechanisms at fixed discrete positions relative to the elongate body of the lanyard assembly. Such configurations limit the ability of the end user to achieve desired configurations of the lanyard assembly beyond those envisioned by the manufacturer.

Accordingly, there is a need for a lightweight and compact lanyard assembly that can achieve multiple configurations, has greater configuration adjustability, and has an inseparable assembly construction.

### BRIEF DESCRIPTION OF THE INVENTION

The present invention discloses a multi-use lanyard assembly that includes an elongate flexible body, a pair of clamps that engage the elongate flexible body, and a pair of clasps that are secured to the opposite distal ends of the elongate flexible body. The elongate flexible body is preferably provided as a cord or a strap that is folded over upon itself to define respective first and second portions of the continuous elongate flexible body. Each of the clamps is oriented to engage both of the first and second portions of the elongate flexible body and be moveable there along. Each of the first and second clamp portions is securable relative to the first and second portions of the elongate flexible body at various discrete positions such that the lanyard assembly can achieve various configurations associated with securing the lanyard assembly and associated accessories relative to a user.

Another aspect of the application that is useable or combinable with one or more of the above aspects or features discloses a lanyard assembly having an elongate flexible body that extends continuously between a first distal end and a second distal end of the elongate flexible body. A first clasp is secured to the elongate flexible body proximate the first distal end and a second clasp is secured to the elongate flexible body proximate second distal end. The lanyard assembly includes a first clamp and a second clamp that each cooperate with a first portion and a second portion of the elongate flexible body wherein the first portion and the second portion of the elongate flexible body each extend between a middle of the elongate flexible body and a respective one of the first distal end and the second distal end of the elongate flexible body.

A further aspect of the application that is useable or combinable with one or more of the above aspects discloses a tether assembly that includes an elongate member that extends continuously between a first end and a second end of the elongate member. The tether assembly includes a first hook that is secured to the first end of the elongate member and a second hook that is secured to the second end of the elongate member. The tether assembly includes a first clamp and a second clamp that each slideably cooperate with the elongate member twice between the first end and the second end of the elongate member and such that the first hook, the second hook, the first clamp and the second clamp are oriented relative to the elongate flexible member such that the second clamp is disposed between the first clamp and each of the first hook and the second hook.

Another aspect of the application that is useable or combinable with one or more of the above aspects discloses a method of forming a multi-use lanyard assembly. The method includes folding a flexible elongate body so that a first portion of the flexible elongate body overlies a second portion of the flexible elongate body. A first clamp and a second clamp are engaged with the first portion and the second portion of the elongate body. A first clasp is secured to a distal end of the first portion of the elongate body and a second clasp is secured to a distal end of the second portion of the elongate body.

These and other aspects of the application will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a perspective view of a tether or lanyard assembly according to one embodiment of the invention;

FIG. 2 is a perspective view of a stop portion of the lanyard assembly shown in FIG. 1;

FIG. 3 is a perspective view of overlapping portions of the lanyard assembly shown in FIG. 1 and shows the adjustable position clamps engaged therewith;

FIG. 4 is a perspective view of the adjustable position clamps removed from the elongate body of the lanyard assembly shown in FIG. 1 and one of the adjustable position clamps in an exploded orientation;

FIG. 5 is a view similar of FIG. 1 wherein the elongate body of the lanyard assembly is formed by a cord;

FIG. 6 is a view similar to FIG. 4 of one of the adjustable position clamps removed from the elongate body of the lanyard assembly shown in FIG. 5;

FIG. 7 is a perspective view of the distal ends of the lanyard assembly shown in FIG. 1 and the clasps associated therewith; and

FIGS. 8-18 are various views of exemplary configurations of the lanyard assembly shown in FIG. 1 for securing the same and/or accessories supported thereby relative to a wearer.

In describing the various embodiments of the invention, which are illustrated in the drawings, specific terminology will be referred to for the sake of clarity. However, it is not intended that the invention be limited to the specific ten ns so selected and it is to be understood that each specific term includes all technical equivalents which operate in a similar manner to accomplish a similar purpose. For example, the words “connected”, “attached”, or terms similar thereto are often used. They are not limited to direct connection unless explicitly recited and include connection through other elements where such connection is recognized as being equivalent by those skilled in the art. The present invention and the various features and advantageous details thereof are explained more fully with reference to the non-limiting embodiments described in detail in the following description.

### DETAILED DESCRIPTION OF THE PREFERRED EMBODIMENT

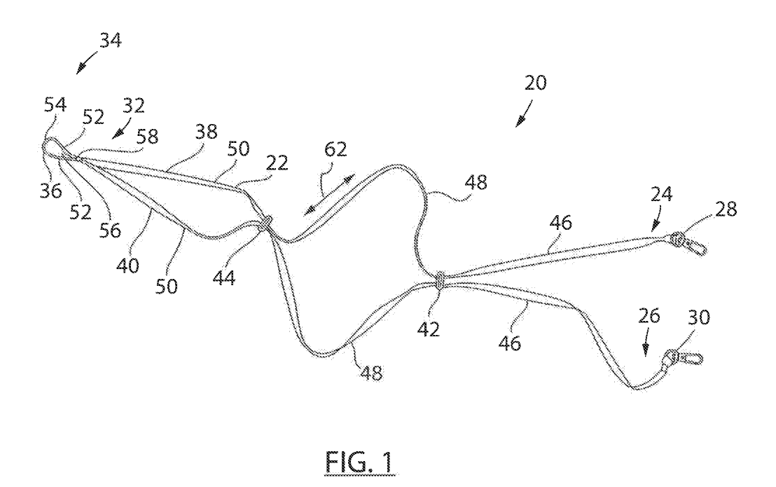

FIG. 1 shows a tether or lanyard assembly 20 according to one embodiment of the present application. Lanyard assembly 20 includes an elongate flexible member or body 22 that extends in a preferably continuous manner from a first distal end 24 to a second distal end 26 thereof. Body 22 is preferably formed as one of a strap, a ribbon, or a cord and preferably of cloth or other material of suitable flexibility. When formed as a strap or ribbon, it is appreciated that body 22 can include an indicia or other marking associated with a source or intended use or advertising associated therewith. A first hook, hook assembly, clasp assembly or clasp 28 is securely connected to first distal end 24 of body 22. A second hook, hook assembly, clasp assembly or clasp 30 is securely connected to second distal end 26 of body 22. A stop 32 is formed proximate an end portion 34 of lanyard assembly 20 that is generally opposite distal ends 24, 26. Said in another way, end portion 34 is defined by a middle portion 36 of body 22 such that body 22 of lanyard assembly 20 includes a first portion 38 that extends between stop 32 and distal end 24 and a second portion 40 that extends between stop 32 and second distal end 26.

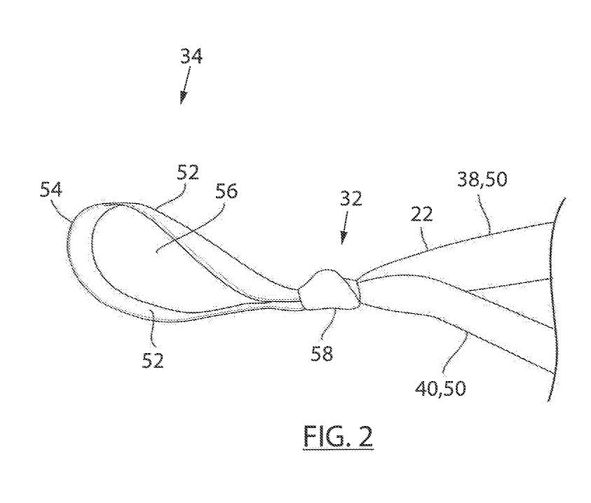

Lanyard assembly 20 includes a first clamp assembly or clamp 42 and a second clamp assembly of clamp 44 that each selectively slideably cooperate with first portion 38 and second portion 40 of body 22 between stop 32 and respective distal ends 24, 26. Each of first portion 38 and second portion 40 of body 22 includes a first section 46 that extends between first clamp 42 and respective distal ends 24, 26, a second section 48 that extends between respective clamps 42 and 44, a third section 50 that extends between respective clamps 42, 44 and stop 32, and a fourth section 52 that extends between stop 32 and a longitudinal center or middle 54 of body 22. Referring to FIGS. 1 and 2, respective sections 52 are generally continuous relative to one another so as to define a loop 56 associated with end portion 34 of lanyard assembly 20. Although stop 32 is shown as being defined by a knot 58 formed in respective portions 38, 40 of elongate body 22, it is appreciated that other methodologies such as a crimp or other connector, stitching or the like, etc., could be provided to form stop 32. Regardless of the connection or formation methodology employed, stop 32 is preferably permanently positioned with respect to a longitudinal axis or length, as indicated by arrow 62, between distal end 24 and distal end 26 of body 22.

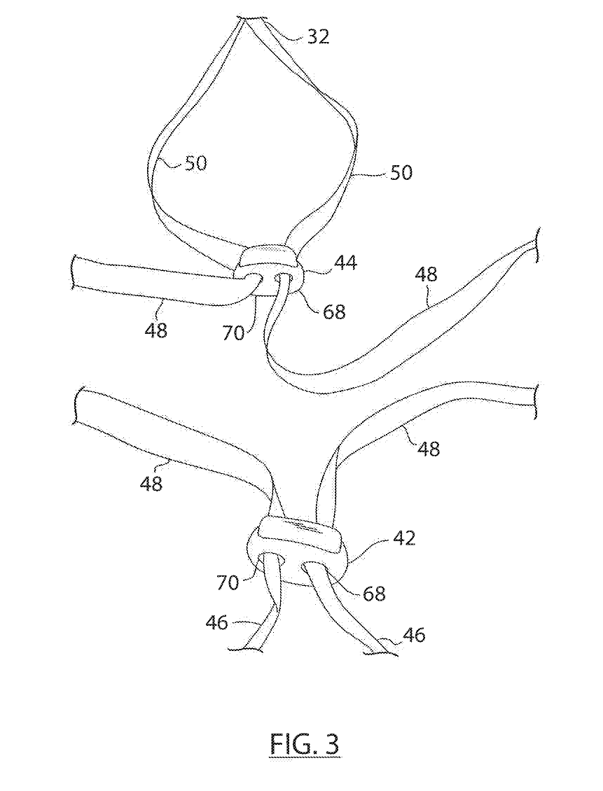

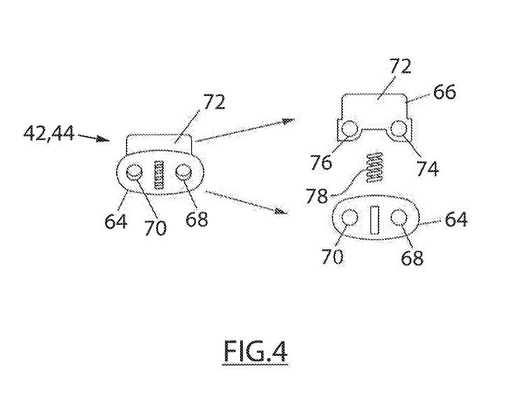

Referring to FIGS. 1, 3, and 4, each of clamps 42, 44 are constructed to selectively slideably cooperate with respective portions 38, 40 of body 22 between stop 32 and respective distal ends 24, 26 thereof. Each of clamps 42, 44 includes a base 64 and an operator 66 that slideably cooperates with base 64. Base 64 includes a first through opening or hole 68 and the second through opening or hole 70. Operator 66 is defined by a body 72 that includes a first through hole 74 and the second through hole 76 that are generally aligned with the orientation of through holes 68, 70 when operator 66 is associated with base 64. Operator 66, base 64, and through holes, 68, 70, 74, 76 are constructed to allow each clamp 42, 44 to be independently positionable relative to first and second portions 38, 40 of elongate body 22 and securable relative thereto when operator 66 is not depressed or is otherwise at an at-rest configuration.

A biasing device 78, such as a spring or the like, is disposed between base 64 arid body 72 of operator 66 and oriented to bias operator 66 relative to base 64 such that a portion of body 72 interferes with the cross-sectional footprint defined by through holes 68, 70. When depressed, through holes 74, 76 associated with operator 66 arc generally aligned with through holes 68, 70 defined by base 64 such that each of portions 38, 40 of elongate flexible body 22 are independently and/or concurrently translatable in either longitudinal direction relative to the respective clamp 42, 44. As alluded to above, when not depressed, operator 66 and base 64, and the through holes defined thereby, achieve an orientation wherein elongate flexible body 22 passing therethrough is compressed so as to restrict longitudinal displacement of respective portions 38, 40 of elongate body 22 relative to the respective clamp 42, 44.

Returning briefly to FIG. 1, it should be appreciated that clamp 42 can be displaced along respective portions 38, 40 of elongate body 22 to any position between distal ends 24, 26 and second clamp 44. Second clamp 44 operates in a similar manner and is displaceable along respective portions 38, 40 of elongate body 22 between first clamp 42 and stop 32. It is appreciated that each of clamps 42, 44 is independently operable to be translatable relative to elongate body 22 and that, when located in close proximity to one another, operation of clamps 42, 44 can be achieved in a concurrent and/or single handed manners.

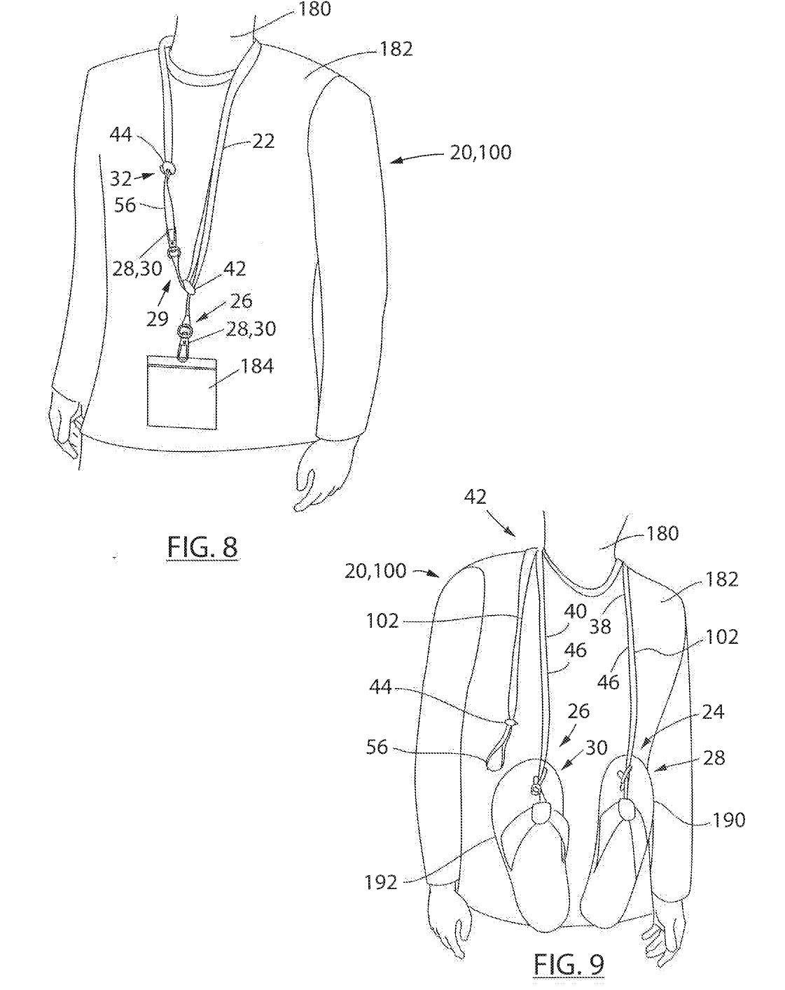

As disclosed further below with respect to FIGS. 8-18, lanyard assembly 20 can achieve various orientations associated with the respective lengths of respective sections 46, 48, 50 associated with portions 38, 40 of elongate body 22 between stop 32 and respective distal ends 24, 26 thereof. It is further appreciated that each of respective portions 38, 40 of elongate body 22 can be independently adjusted relative to respective clamps 42, 44 such that a longitudinal length associated with respective sections 46, 48, 50 need not be the same with respect to respective portions 38, 40 of elongate body 22 depending on a user's preference associated with use of lanyard assembly 20.

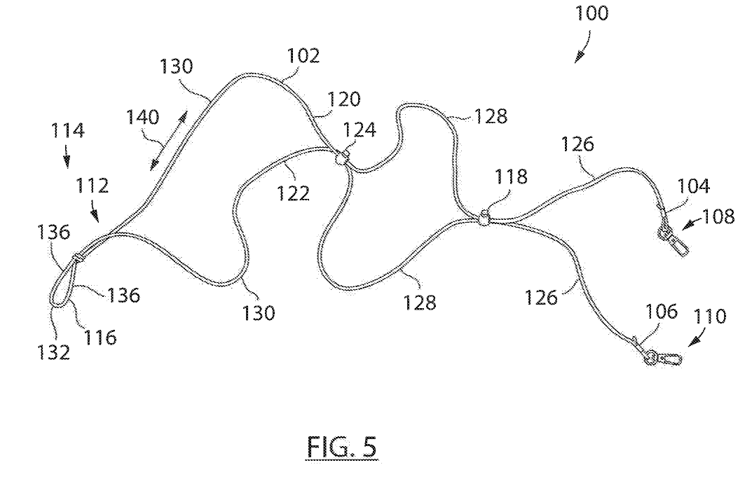

FIG. 5 shows a tether or lanyard assembly 100 according to another embodiment of the application. Like lanyard assembly 20, lanyard assembly 100 includes an elongate flexible body 102 that extends in a preferably continuous manner from a first distal end 104 to a second distal end 106 of body 102. Whereas flexible body 22 of lanyard assembly 20 is thrilled as a ribbon or strap, flexible body 102 of lanyard assembly 100 is formed as a cord. Body 102 may be formed of a single continuous strand of material or formed by a plurality of braided individual strands of material.

Like lanyard assembly 20, lanyard assembly 100 includes a first hook, hook assembly, clasp assembly, or first clasp 108 that is secured to first distal end 104 and a second hook, hook assembly, clasp assembly or second clasp 110 that is secured to second distal end 106 of body 102. A stop 112 is formed proximate an opposite end 114 of lanyard assembly 100 and defines a loop 116 associated there with. A first clamp 118 slideably cooperates with respective portions 120, 122 of elongate body 102 and is disposed between respective distal ends 104, 106 and a second clamp 124. Second clamp 124 also selectively slideably cooperates with respective portions 120, 122 of elongate body 102 and is disposed between first clamp 118 and stop 112. Clamps 118, 124 segregate first and second portions 120, 122 of elongate body 102 into respective first sections 126, seconds sections 128, and third sections 130 between stop 112 and respective distal ends 104, 106. Loop 116 formed proximate a middle 132 of elongate body 102 and stop 112 and defined by respective fourth sections 136 of respective portions 120, 122 of elongate flexible body 102. Like lanyard assembly 20, clamps 118, 124 slideably cooperate in the respective longitudinal direction, as indicated by arrow 140, of portions 120, 122 of elongate body 102 between stop 112 and distal ends 104, 106 so as to manipulate the relative longitudinal length and/or shape associated with sections 126, 128, 130 associated with elongated body 102.

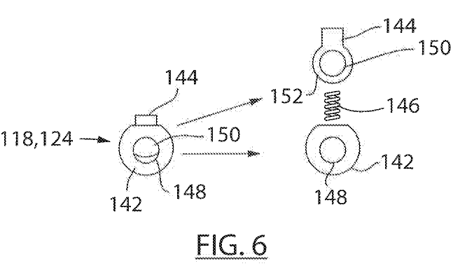

Referring to FIG. 6, each of clamps 118, 124 includes a base 142, an operator 144, and a biasing device 146, such as a spring, that is disposed between the respective base and operator. Base 142 defines a single through hole, passage, or opening 148 that is oriented to be generally aligned with a through hole, passage, or opening 150 defined by operator 144. Depressing operator 144 relative to base 142 allows openings 148, 150 to be generally aligned with one another such that respective portions 120, 122 associated with elongate body 102 are freely translatable therethrough. When operator 144 is positioned at an at-rest orientation or otherwise not depressed, a portion of body 152 of operator 144 generally obstructs opening 148 defined by base 142 such that portions 120, 122 of elongate flexible body 102 are biased into engagement with respective portions of base 142 and body 152 of operator 144 so as to restrain the respective clamp 118, 124 relative to a respective position along portions 120, 122 of elongate flexible body 102.

Whereas clamps 42, 44 includes a pair of openings 68, 70 which maintain isolation between respective portions 38, 40 of elongate body 22 of lanyard assembly 20, clamps 118, 124 include a single opening that is constructed to accommodate both of respective portions 120, 122 of elongate flexible body 102 of lanyard assembly 100. It is appreciated that each of clamps 42, 44, 118, 124 accommodate both concurrent or individual translation of respective portions 38, 40, 120, 122 of respective lanyard assemblies 20, 100 relative to the discrete clamps 42, 44, 118, 124.

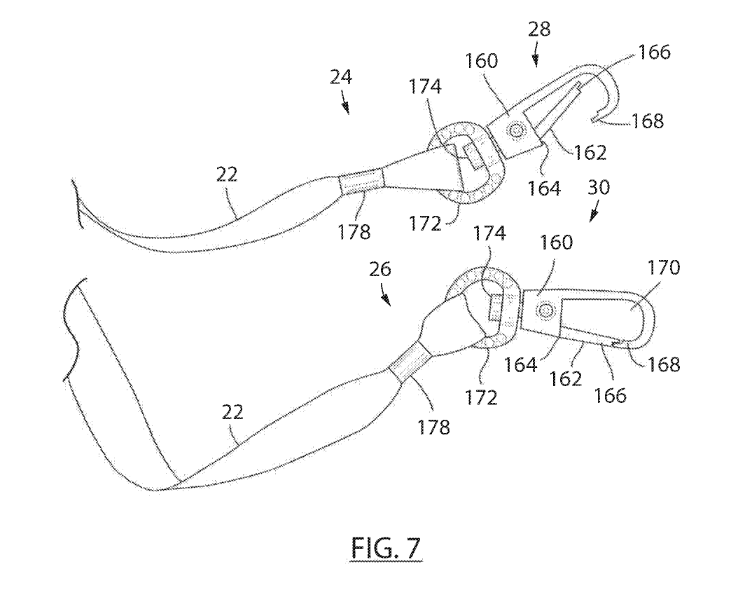

FIG. 7 shows a detail view of clasps 28, 30 associated with elongate flexible body 22. It is appreciated that clasps 108, 110 associated with lanyard assembly 100 have a similar construction as clasps 28, 30 as described below. Each clasp 28, 30 includes a base 160 and an arm 162 that is movable relative thereto. In a preferred embodiment, each arm 162 includes a first end 164 that is pivotably connected to the respective base 160 of the respective clasp 28, 30. A second end 166 of each clasp 28, 30 is constructed to cooperate with a distal end 168 defined by the respective base 160. Arm 162 is movable between an open position relative to base 160, as shown by clasp 28, and is biased toward a closed position, as shown by the orientation associated with clasp 30. When oriented in the closed position, each clasp 28, 30 defines a closed loop 170 that is circumferentially bounded by the cooperation of base 160 and the respective arm 162. In a preferred embodiment, each clasp 28, 30 includes an optional loop or ring 172 that is rotationally connected via a post 174 associated with the respective base 160. Respective distal ends 24, 26 of elongate body 22 are secured to a respective ring 172 by a crimp ring 178 or similar, preferably permanent, connection methodology such as stitching and/or knotting of the respective distal end 24, 26 associated with elongate body 22 upon itself.

Referring briefly to FIGS. 1 and 5, it should be appreciated that each of lanyard assemblies 20, 100 includes respective portions 38, 40, 120, 122 that generally overlie one another between respective stops 32, 112 and respective distal ends 24, 26, 104, 106. The slideable translation of each of clamps 42, 44, 118, 124 along the respective portions 38, 40, 120, 122 of the respective elongate flexible body 22, 102 between stop 32, 112 and distal ends 24, 26, 104, 106 allows each of lanyard assemblies 20, 100 to achieve various configurations associated with securing a respective lanyard assembly relative to a user and relative to various accessories intended to be supported thereby. Preferably, each elongate flexible body 22, 102 associated with each of lanyard assemblies 20, 100 has an overall longitudinal length of approximately 80 inches such that each lanyard assembly has an approximate overlapping length of approximately 40 inches when in the orientation shown in FIGS. 1 and 5. Although each of lanyard assemblies 20, 100 could be provided in various lengths, preferably, each of lanyard assemblies 20, 100 has a minimum length that is at least sufficient such that the respective portions thereof can circumscribe the waist of a user in a non-overlapping configuration. It is further appreciated that each of lanyard assemblies 20, 100 can be provided in both youth and adult sizes.

As shown in FIG. 8, one configuration of lanyard assembly 20, 100 provides a loop that can be conveniently worn about a neck 180 of wearer 182. In one such configuration, one of clasps 28, 30 is secured to loop 56 associated with elongate body 22 and a badge or other identification container 184 can be retained by cooperation with the other clasp 28, 30 so that the badge or identification container can be disposed at a generally forward facing orientation relative to the wearer 182. Clamp 42 is positioned proximate distal ends 24, 26 and clamp 44 is positioned proximate stop 32.

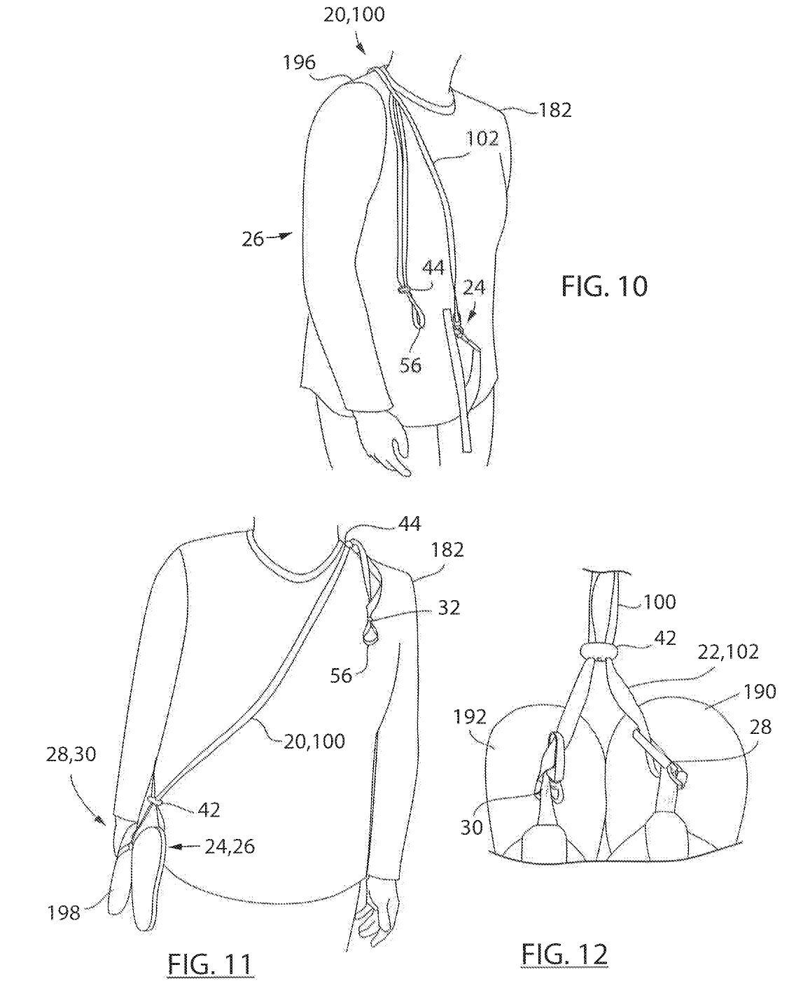

As shown in FIG. 9, and an alternate configuration, clamp 42 is disposed along elongate body 102 so as to be more remote from respective distal ends 24, 26 and to be positioned generally behind the neck 180 of the wearer 182. Clamp 44 can be positioned proximate loop 56 or translated along elongate body 102 toward clamp 42. First section 46 of elongate body 102 extends along the chest of wearer 182 such that each of clasps 28, 30 can be used to secure accessories, such as individual footwear such as sandals 190, 192, or other items or accessories relative to wearer 182. It should be appreciated that each of clasps 28, 30 can be passed through a structural portion associated with a respective accessory or item such as respective sandals 190, 192, and engage elongate body 102 via the closed loop 170 defined by respective clasps 28, 30. It should be further appreciated that clasps 28, 30 can be engaged with the opposing portion 38, 40 associated with section 46 of elongate flexible body 102 so as to define a loop between clamp 42 and respective distal ends 24, 26 associated with elongate body 102 with the users neck 180 positioned therein. Alternatively, as shown in FIG. 10, it should be appreciated that from the configuration shown in FIG. 9, lanyard assembly 20, 100 can be slung over a shoulder 196 of wearer 182 such that respective distal ends 24, 26 associated with lanyard assembly 20, 100 depend from the chest and from the back of wearer 182.

In yet another configuration as shown in FIG. 11, clamp 42 is disposed proximate distal ends 24, 26 of lanyard assembly 20, 100 and clamp 44 is disposed near stop 32 so as to provide a cross body front and back orientation of lanyard assembly 100. When an accessory 198 is secured thereto, clasps 28, 30 can be conveniently passed about a structural portion of respective accessories, such as sandals 190, 192, that accommodate passage of respective clasps 28, 30 therethrough in a secure manner such that respective clasps 28, 30 can selectively securely engage the respective elongate flexible body 22, 102 such that the remainder of the respective lanyard assembly 20, 100 can be utilized for securing the respective lanyard assembly 20, 100 relative to the user and in an orientation preferable to the user.

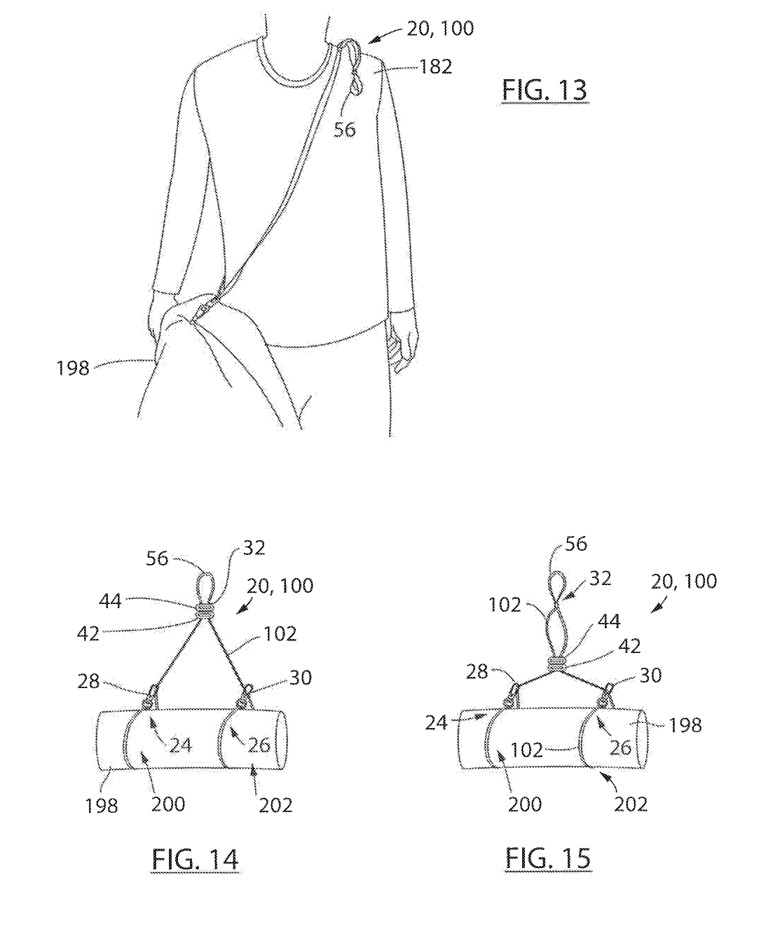

Referring to FIGS. 13-15, it is further appreciated that lanyard assemblies 20, 100 can be used to cooperate with larger accessories such as towels, jackets, etc. in various configurations wherein the respective accessory, such as a jacket or a towel 198, defines a portion of the closure loop associated with supporting the accessory relative to wearer 182 and/or other configurations wherein the respective lanyard assembly securely cooperates with the underlying accessory and defines a closed loop associated with securing the respective lanyard assembly 20, 100 relative to the underlying user 182. For instance, as shown in FIG. 14 clamps 44, 42 are disposed proximate loop 56 and clasps 28, 30 are oriented such that a portion of elongate body 102 of respective lanyard assembly 20, 100 extends circumferentially about the accessory 198 and is secured to elongate body 102 so as to form a slip or cinch closure arrangement 200, 202 associated with each of the opposite distal ends 24, 26 associated with the respective lanyard assembly 20, 100.

In an alternate configuration as shown in FIG. 15, each of clamps 42, 44 are disposed along elongate body 102 so as to be positioned nearer respective distal ends 24, 26 then stop 32. Respective clasps 28, 30 each cooperate with a respective portion associated with elongate body 102 and define respective slip or cinch closures 200, 202 associated therewith. Such considerations mitigate the unintentional in undesired separation of a respective accessory 198 relative to the corresponding lanyard assembly 20, 100 until desired.

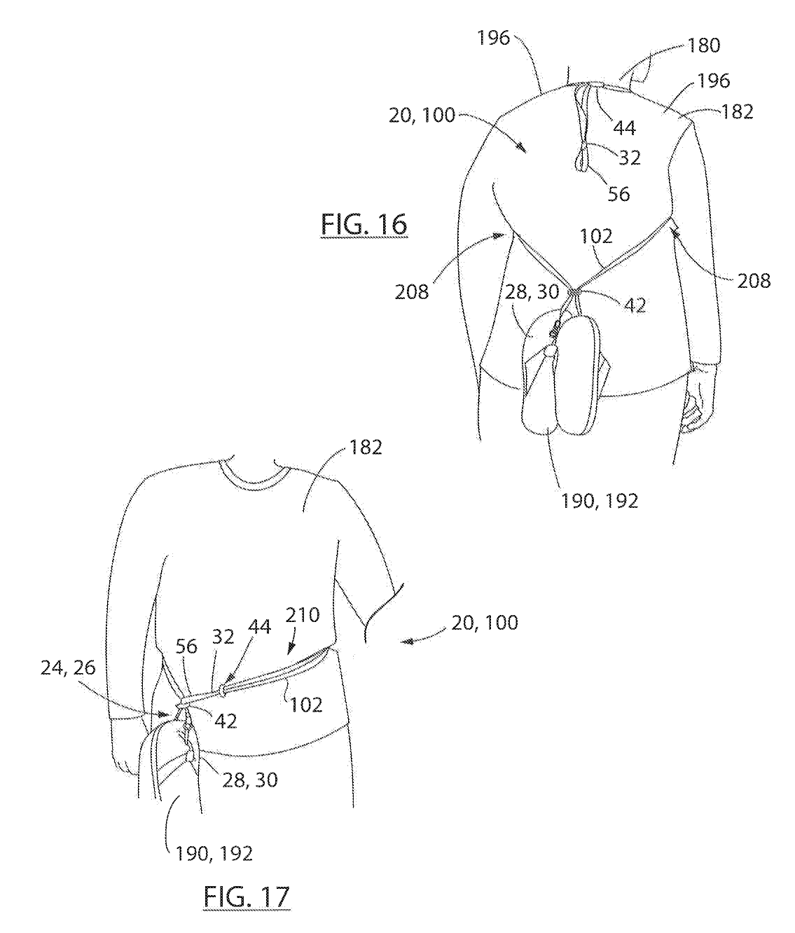

FIG. 16 shows yet another configuration associated with securing accessories such as a pair of nip-flops or sandals 190, 192 relative to wearer 182 and that the sandals 190, 192 are oriented along the hack of the wearer. As shown in FIG. 16, clamp 44 is disposed proximate stop 32 and generally rearward of the neck 180 of wearer 182. Elongate flexible body 102 extends forward and downward from the neck to the underarm area 208 of wearer 182. Clasps 28, 30 cooperate with accessories 190, 192 such that accessories 190, 192 are secured relative to wearer 182 along the wearer's back. Such a configuration frees the forward facing portion of wearer 182 as well as the hands and arms thereof for other uses, such as carrying a child or the like.

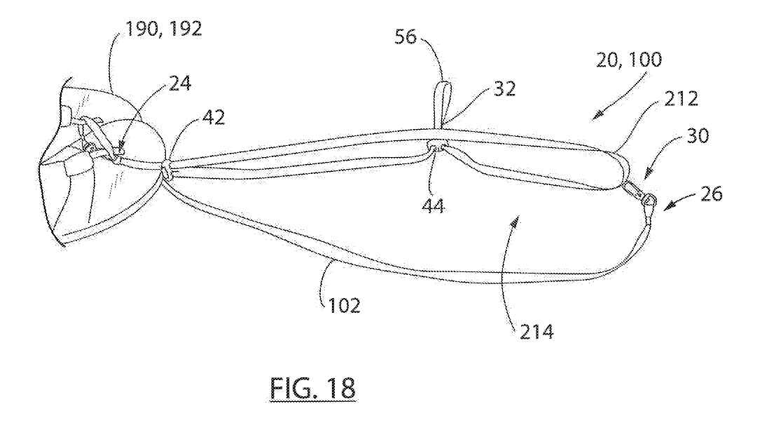

FIGS. 17 and 18 show yet another configuration associated with use of lanyard assembly 20, 100 for placement about the waist of wearer 182. As shown in the configuration of FIG. 17, distal ends 24, 26 associated with clasps 28, 30 are passed through loop 56 of lanyard assembly 20, 100 so as to form a slip or cinch opening 210 when lanyard assembly 20, 100 is disposed about the waist of a user and an item 190, 192 is secured thereat. Referring to FIG. 18, in an alternate configuration, one distal end 24 and the clasp 28 associated therewith can be secured to an accessory 190, 192 and second distal end 26 and the clasp 30 associated there with can be secured to an opposing portion 212 associated with elongate flexible body 102. Like the configuration shown in FIG. 17, the configuration shown in FIG. 18 also defines a slip or cinch opening 214 associated with securing accessories 190, 192 or other items relative to the anatomy of the wearer.

Although described above as being generally directed to securing items relative to the neck, shoulders, and/or waist of the wearer, it is appreciated that lanyard assemblies 20, 100 are constructed to be conveniently configured for securing carried items relative to the wearer about any desired portion of the anatomy thereof such as the wrist, hand, a thigh, or the like, as well as the neck, torso, shoulders, or waist thereof. Each of lanyard assemblies 20, 100 provides a highly adjustable and uniquely configurable lanyard assembly for supporting items relative to user in various locations relative to the anatomy of the wearer as well as in various configurations associated with cooperating with the underlying items intended to be transported. Further, the flexibility associated with lanyard assemblies 20, 100 allows convenient and contact storage of the same when not in use. The non-removable construction associated with the elongate flexible body, the clasps, and the clamps mitigates loss or separation of any of the discrete portions of lanyard assembly 20, 100 so as to maintain the desired utility of the same.

While the invention has been particularly shown, and described with reference to preferred embodiments thereof, it will be understood by those skilled in the art that the foregoing and other changes in form and details may be made therein without departing from the spirit and scope of the invention.

Therefore, one embodiment disclosed in the present application includes a lanyard assembly having an elongate flexible body that extends continuously between a first distal end and a second distal end of the elongate flexible body. A first clasp is secured to the elongate flexible body proximate the first distal end and a second clasp is secured to the elongate flexible body proximate second distal end. The lanyard assembly includes a first clamp and a second clamp that each cooperate with a first portion and a second portion of the elongate flexible body wherein the first portion and the second portion of the elongate flexible body each extend between a middle of the elongate flexible body and a respective one of the first distal end and the second distal end of the elongate flexible body.

Another embodiment disclosed in the present application that is usable or combinable with one or more of the aspects, features, objects, or elements associated with the above embodiments includes a tether assembly having an elongate member that extends continuously between a first end and a second end of the elongate member. The tether assembly includes a first hook that is secured to the first end of the elongate member and a second hook that is secured to the second end of the elongate member. The tether assembly includes a first clamp and a second clamp that each slideably cooperate with the elongate member twice between the first end and the second end of the elongate member and such that the first hook, the second hook, the first clamp, and the second clamp are oriented relative to the elongate flexible member such that the second clamp is disposed between the first clamp and each of the first hook and the second hook.

Another embodiment disclosed in the present application that is usable or combinable with one or more of the aspects, features, objects, or elements of the above embodiments includes a method of forming a multi-use lanyard assembly. The method includes folding a flexible elongate body so that a first portion of the flexible elongate body overlies a second portion of the flexible elongate body. A first clamp and a second clamp arc engaged with the first portion and the second portion of the elongate body. A first clasp is secured to a distal end of the first portion of the elongate body and a second clasp is secured to a distal end of the second portion of the elongate body.

It is appreciated that the various lanyard or tether assemblies disclosed herein include various additions, modifications, and rearrangements that are within capabilities of those skilled in the art from the disclosure of the present application. It is intended that the appended claims cover all such additions, modifications, and rearrangements. Expedient embodiments of the present invention are differentiated by the appended claims which also form part of the specification.

1. A lanyard assembly comprising:
an elongate flexible body that extends continuously between a first distal end and a second distal end of the elongate flexible body;
a first clasp secured to the elongate flexible body proximate the first distal end and a second clasp secured to the elongate flexible body proximate the second distal end;
a first clamp and a second clamp that each cooperate with a first portion and a second portion of the elongate flexible body wherein the first portion of the elongate flexible body extends between the first distal end and a middle of the elongate flexible body and the second portion of the elongate flexible body extends between the second distal end and the middle of the elongate flexible body; and
a stop formed proximate the middle of the elongate flexible body.

2. The lanyard assembly of claim 1 wherein the elongate flexible body is further defined as one of a strap, a ribbon, or a cord.

3. The lanyard assembly of claim 1 wherein each of the first clamp and the second clamp are further defined as spring lock assemblies and are independently securable to the elongate flexible body.

4. The lanyard assembly of claim 3 wherein each of the first clamp and the second clamp further define at least one passage configured to slideably cooperate with the first portion and the second portion of the elongate flexible body.

5. The lanyard assembly of claim 4 wherein the at least one passage is further defined as a first passage configured to slideably cooperate with the first portion of the elongate flexible body and a second passage configured to slideably cooperate with the second portion of the elongate flexible body.

6. The lanyard assembly of claim 1 wherein the first clamp and the second clamp are movable along the first portion and the second portion of the elongate flexible body between the stop and the first clasp and the second clasp.

7. The lanyard assembly of claim 1 wherein the first clasp and the second clasp each include a base that is secured to the elongate flexible body and a lock awl that is movable relative to the base and biased toward a closed position wherein opposing ends of the lock arm are in contact with the base.

8. The lanyard assembly of claim 7 wherein the base includes a first portion that supports the lock arm and a second portion that is secured to the elongate flexible body and movably cooperates with the first portion.

9. A tether assembly comprising:
an elongate member that extends continuously between a first end and a second end;
a first hook secured to the first end of the elongate member;
a second hook secured to the second end of the elongate member;
a first clamp that slideably cooperates with the elongate member twice between the first end and the second end;
a second clamp that slideably cooperates with the elongate member twice between the first end and the second end and such that the first hook, second hook, first clamp, and second clamp are oriented relative to the elongate flexible member such that the second clamp is disposed between the first clamp and each of the first hook and the second hook; and
a stop defined by the elongate member and oriented along a length of the elongate member that is to a side of the first clamp that is opposite the second clamp.

10. (canceled)

11. The tether assembly of claim 9 wherein each of the first clamp and the second clamp is further defined as a base, an operator, and a biasing device wherein the base and the operator are shaped to define at least one passage that is constructed to allow the elongate member to pass therethough and the biasing device is oriented to cause the operator to reduce a cross-sectional size of the least one passage.

12. The tether assembly of claim 11 wherein the at least one passage is further defined as a first passage associated with passage of a first portion of the elongate member through the respective clamp and a second passage associated with passage of a second portion of the elongate member through the respective clamp and wherein the first passage and the second passage are fluidly isolated from one another.

13. The tether assembly of claim 9 wherein each of the first hook and the second hook are further defined by a base and a lock that movably cooperates with the respective base.

14. The tether assembly of claim 13 wherein each base further comprises a first base portion that supports the lock and a second base portion that is movable relative to the first base portion and is secured to the elongate member.

15. The tether assembly of claim 9 wherein the elongate member is further defined as one of a strap, a ribbon, or a cord.

16. A method of forming a multi-use lanyard assembly, the method comprising:
folding a flexible elongate body so that a first portion of the flexible elongate body overlies a second portion of the flexible elongate body;
engaging a first clamp with the first portion and the second portion of the elongate body;
engaging a second clamp with the first portion and the second portion of the elongate body;
securing a first clasp to a distal end of the first portion of the elongate body;
securing a second clasp to a distal end of the second portion of the elongate body; and
forming a stop proximate a middle portion of the flexible elongate body and between the first portion and the second portion of the flexible elongate body.

17. The method of claim 16 wherein the stop is configured to prevent translation of respective first clamp and second clamp toward the middle portion of the flexible elongate body.

18. The method of claim 16 further comprising providing the first clasp and second clasp with a selectively operable closure mechanism that is biased toward a closed configuration.

19. The method of claim 16 further comprising providing each of the first clamp and the second clamp as at least one of a strap clamp and a cord clamp wherein a portion of the at least one of the strap clamp and the cord clamp is biased into engagement with the flexible elongate body.

20. The method of claim 16 further comprising orienting the stop to prevent translation of at least one of the first clamp and the second clamp relative to the elongate flexible body beyond the stop.
